(19) United States
(12) Patent Application Publication
(10) Pub. No.: US 2002/0122869 A1
(43) Pub. Date: Sep. 5, 2002

(54) Aroma and flavor enhancer for pet food

(76) Inventor: Hal D. Lilley, North East, PA (US)

Correspondence Address: Hal D. Lilley, 8323 Ox Bow Road, North East, PA, 16428, US

(21) Appl. No.: 09/798,214

(22) Filed: Mar. 5, 2001

(51) Int. Cl. A23L 1/222

(52) U.S. Cl. 426/651

(57) ABSTRACT

This invention is a pre-serving additive of aroma and flavor enhancers for pet food that is made of edible products but will not add any measurable unwanted food value. When applied immediately prior to serving, it produces an attractive, lingering aroma and/or aromas to attract the animal to the pet food. Its concentrated flavor and/or flavors enhances the palatability of the pet food.

### BACKGROUND OF THE INVENTION

All pets need to eat a nutritious, well-balanced diet to live a healthy life. Many years ago, due to the role of pets in the family, economics, and lifestyle, most pets were kept outside the home and fed table scraps. For the last 50 years, pet food manufacturers have been making a very good, nutritious product that meets pets dietary needs. However, most of these bulk pet foods have been generally bland and tasteless, eaten only when the animal is very hungry. Today most pets live in the house with the family. To keep a pet healthy and maintain good digestive function and dependable bowel movements, they must be fed a consistent diet. This becomes more difficult when a pet is faced with tasteless food and smells people food at the same time. But feeding table scraps of people food to pets can upset their digestive tract, which can lead to loose and uncontrollable bowel movements, or constipation. This problem con also occur when changing types or brands of food or switching to canned food to add variety to their diet. There are many situations which can cause a pet to loose it's appetite: for example—moving to a new home; addition of a new pet to the household; children returning to school; adults away from home on business; being placed in a kennel or other unfamiliar surroundings for vacation purposes. Some pets don't eat at all when the owners are away, then overeat when they return. This lack of appetite can seriously endanger the health of a pet, especially older animals, or pets who are on a strict, regimented diet due to a previously diagnosed illness or condition. Changing brands or types of food, or switching to canned food to encourage a pet to eat would not be an option in these cases.

These problems can be solved by the use of a product created specifically to enhance the aroma and flavor of bulk and/or dry pet food that is nutritionally balanced but lacking in flavor, variety, and appeal. It provides the pet with a variety of aromas to attract a pet to its food, and a variety of flavors to satisfy the pet, without changing brands or types of food. It keeps the pet on a healthy, consistant diet. It has been used and found by veterinarians to be a very good treatment tool in maintaining proper diet in pets that have been kenneled due to family vacations, and animals under veterinary care after surgery. The use of this product has made it much easier to control the diets of obese pets, and pets with other restricted diets due to medical conditions. It can greatly reduce or eliminate pet eating disorders, without adding any measurable unwanted food value to upset the digestive process.

Applicant has reviewed the patent documents of U.S. Pat. Nos. 5,894,029-Brown et al, 5,690,988-Lin et al, 5,656,312-Erasmus et al, 5,538,743-Heinemann et al, 6,007,851-Shoenmaker et al, 5,798,132-Chen et al, 5,089,287-Michaelson, 6,086,939-Janot et al, and has found them to be for food and/or pet food products, and more specifically some do pertain to applications of coatings on pet food to enhance palatability. However, this is a process and coating that is used during the commercial process of manufacturing the pet food, and is applied in a commercial manufacturing facility prior to packaging. Although this is an enhancement. of pet food palatability, there is no reference to enhancing The aroma and flavor immediately prior to the serving of the pet food.

### BRIEF DESCRIPTION OF THE INVENTION

This invention is an aroma and flavor enhancer for pet food that attracts pets to eat their food, improves palatability, and is applied to the food immediately prior to serving.

### DETAILED DESCRIPTION OF THE INVENTION

This invention is a food product that may be a liquid consisting of, but not limited to, a combination of edible oils, emulsifiers, and commercially available flavoring oils and/or solids that are of such a viscosity or grit that they can be sprayed or misted on pet food immediately prior to serving, so that a lingering aroma remains in the air before the serving of the pet food. The concentrated flavoring enhances the flavor or can change the flavor of the pet food and improve the palatability. This invention may also be a dry sprayable powder that can add to or change the flavor of the pet food just prior to serving, and also be of a fine enough powder to leave a dust in the air to produce a lingering aroma just prior to serving.

1. An aroma and flavor enhancing and/ or changing additive to be applied to pet food immediately prior to serving, that will not add any measurable unwanted food value.

2. A pet food additive that can be sprayed or misted just prior to serving, with a mechanical spray device—ie glass cleaner spray bottle; or an aerosol spray can—ie. underarm deoderant powder spray can, air freshener spray can, hair spray can.

3. An additive using edible food materials that are of such a liquid viscosity and/or fineness of dry powder that after being sprayed or misted will leave an attractive aroma-producing mist or an aroma-producing dust that will linger in the air to attract the pet to its food.
